(19) United States
(12) Patent Application Publication
(10) Pub. No.: US 2022/0062098 A1
(43) Pub. Date: Mar. 3, 2022

(54) Portable CPR Robot

(71) Applicant: Aamir Zain Jamal, Claremont, CA (US)

(72) Inventor: Aamir Zain Jamal, Claremont, CA (US)

(21) Appl. No.: 17/459,207

(22) Filed: Aug. 27, 2021

Related U.S. Application Data
(60) Provisional application No. 63/072,143, filed on Aug. 29, 2020.

(51) Int. Cl. A61H 31/00

(52) U.S. Cl. CPC A61H 31/006; A61H 2201/1659; A61H 2201/0119; A61H 2201/5046; A61H 2201/1238; A61H 2201/5097; A61H 2201/5082; A61H 2230/065; A61H 2201/107; A61H 2201/10; A61H 2205/083; A61H 2201/5071

(57) ABSTRACT

Improvements in a device that provides cardiopulmonary recitation (CPR). The portable robot extends from a base from a single side where the robot can be wheeled over a patient. The compression head of the portable CPR robot extends from only one side of the base to leave one-side of the patient open for doctors to assess the patient. The rate and force of the chest compressions can be adjusted. A plurality of sensors that can monitor and adjust in real-time based upon the condition of the patient. The device can have additional function including, but not be limited to X-ray, air/breathing function, defibrillator as well as abdominal compression capability. Communications can link the portable CPR robot to other medical information with a wired, or more preferably a wireless link to the patients records and medical diagnostic tools.

### CROSS REFERENCE TO RELATED APPLICATIONS

This application claims the benefit of Provisional Application Ser. No. 63/072,143 filed Aug. 29, 2020, the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

This invention relates to improvements in providing Cardiopulmonary Recitation (CPR) to a person. More particularly, the present portable CPR robot can be rolled over the top of a person and activated to provide CPR to a person thereby freeing a doctor to provide other assistance to the patient.

Description of Related Art including information disclosed under 37 CFR 1.97 and 1.98.

When a person's heart stops beating one of the best ways to try and re-start the heart and have some blood movement is with chest compressions that is typically known as Cardiopulmonary Recitation (CPR). This is performed by repetitively compressing the chest in the med-sternal region with a patient supine and in the horizontal plane to propel blood out of the non-beating heart to the brain and other vital organs. To perform CPR a person will usually straddle the patient and press onto the chest at a fixed interval. This is usually performed nearly non-stop and prevents the person performing CPR to perform nearly any other task.

To relieve the person from performing chest compressions some inventions have been published and/or patented for machines that handle the chest compressions. Exemplary examples of patents and or publication that try to address this/these problem(s) are identified and discussed below.

U.S. Pat. No. 3,509,899 issued on May 5, 1970, to C. E. Hewson and is titled Heart and Lung Resuscitator. This patent discloses a pneumatic pulse circuit having an oxygen inlet and outlet connected through a pneumatically operated valve which opens and closes sequentially to cause the outlet to discharge intermittently. This patent requires a person to be strapped around their chest and this can take a significant amount of time while CPR is stopped.

U.S. Pat. No. 8,657,764 issued on Feb. 25, 2014, to Ben King and is titled Gas-driven Chest Compression Apparatus. This patent discloses a gas-driven chest compression apparatus for cardiopulmonary resuscitation (CPR) comprises a flexible pneumatic actuator, capable of axial contraction when fed with a pressurized driving gas and means for controlling the contraction thereof. This gas-driven device also requires placing the CPR device around the patient and making multiple adjustments to “fit” the patient.

U.S. Pat. No. 9,211,229 issued on Dec. 15, 2015, to Uday Kiran V. Illindala and is titled Piston-based Chest Compression Device with Belt Drive. This patent discloses a hybrid chest compression device includes a backboard with a motor and a drive spool housed within the backboard. There is also a piston support frame secured to the backboard forming a patient channel between the piston support frame and the backboard. There is a belt operably secured to the drive spool and enclosed within the backboard and the piston support frame and a piston operably housed within the piston support frame wherein motion of the belt actuates motion of the piston. This patent requires fitting the device under the arms of a patient and sliding the person on a table to obtain the optimal position.

U.S. Pat. No. 10,406,068 issued on Sep. 10, 2019to Keith G. Lurie et al., and is titled Lockable Head Up Cardiopulmonary Resuscitation Support Device. This patent discloses an elevation device also includes a chest compression device coupled with the support arm. An elevation device used in the performance of cardiopulmonary resuscitation (CPR) and after resuscitation includes a base and an upper support operably coupled to the base. The upper support is configured to incline at an angle relative to the base to elevate an individual's upper back, shoulders, and head. While this patent is positionable around the shoulders of a person, it essentially requires the person to be placed within the support device prior to needing CPR.

What is needed is a portable CPR robot that can be wheeled to a bed or gurney, quickly positioned in the proper location, and started. This relieves the doctor to perform other tasks and leaves one-side of the patient clear. The proposed portable CPR robot provides the solution.

### BRIEF SUMMARY OF THE INVENTION

It is an object of the portable CPR robot to provide chest compressions to a person. The rate and force of the chest compressions can be adjusted. Information on the patient, such as age, weight and gender can be entered to establish an initial force and rate. These values can be adjusted as needed and/or the portable CPR robot can make changes based upon patient readings.

It is an object of the portable CPR robot to have a plurality of sensors that can monitor and adjust in real-time based upon the condition of the patient. After the portable CPR robot has made a chest compression the portable CPR robot can bring the compression pad into contact with the person to read O2 levels, temperature and EKG, ECG as the portable CPR robot rests between chest compressions using tactile, audible, and other sensors. The portable CPR robot may further include ultrasonic sensors that can allow the portable CPR robot to position or re-position the compression head.

It is another object of the portable CPR robot to be portable on wheels to allow the portable CPR robot to be quickly rolled over a patient as well as quickly rolled away from a patient once their vital signs indicate further CPR is no longer required. The compression head of the portable CPR robot extends from only one side of the base to leave one-side of the patient open for doctors to assess the patient. The base is sufficiently weighted to offset the downward force of the chest compressions. The base can roll under the bed or gurney or can be located at the side or completely away from the bed.

It is another object of the portable CPR robot to operate autonomously where, once the portable CPR robot is rolled into proximity of the patient, the portable CPR robot can adjust the position of the change the compression head to locate the optimal position and begin CPR on the patient. This frees the doctor or care giver to focus on other areas of patient care as the portable CPR robot monitors vital signs of the patient and continues to provide CPR at the optimal rate and position for the patient.

It is still another object of the portable CPR robot to include additional functions and communications. The functions can include, but not be limited to X-ray, air/breathing function, defibrillator as well as abdominal compression capability. Communications can link the portable CPR robot to other medical information with a wired, or more preferably a wireless link to the patients records and medical diagnostic tools.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a perspective view of a portable CPR robot.

FIG. 2 shows a side plan view of the portable CPR robot.

FIG. 3 shows another perspective view of the portable CPR robot.

FIG. 4 shows a perspective view of the portable CPR robot over a hospital bed.

FIG. 5 shows a block diagram of the electrical components of the portable CPR robot.

FIG. 6 shows a flow chart of using the portable CPR robot.

### DETAILED DESCRIPTION OF THE INVENTION

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing particular embodiments only and is not intended to be limiting of the technology. As used herein, the singular forms “a,” “an,” and “the” are intended to include the plural forms as well, unless the context clearly indicates otherwise.

It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters.

Item Numbers and Description

```
  10 portable CPR robot
  11 bed
  18 heart
  19 patient
  20 compression pad
  21 compression display
  22 down column
  23 adjustable chest arm
  24 cylinder
  25 pressure sensor
  40 vertical extension
  41 vertical post
  42 vertical rotation
  43 horizontal arm
  44 horizontal extension
  45 pivot
  46 pivot
  60 base
  61 drive wheel
  62 pivot wheel
  63 battery
  64 battery
  65 external power
  70 air supply
  71 compressor
  72 pressure gauge
  73 tube adapter
  74 supply tube
  75 air controller
  76 air line(s)
  77 breathing mask
  80 controller
  81 transmitter/receiver
  82 antenna
  83 signal
  94 compress
  95 vertical
  96 extend
  97 rotate
  98 rotate
  99 vertical
100 handle
110 start
111 position
112 wheel lock
113 enter data
114 adjust default
115 in position
116 stroke
117 display message
118 compression good
119 alert/alarm
120 sensors OK
150 stop
```

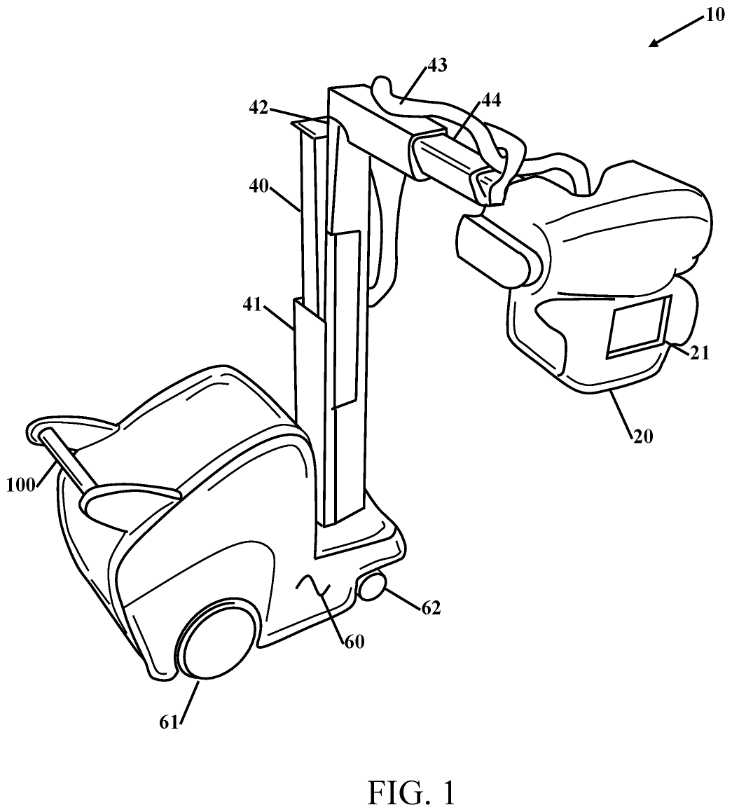

FIG. 1 shows a perspective view of a portable CPR robot 10. The portable CPR robot 10 has a weighted base 60 that is sufficiently weighted to resist rotational forces when maximum force is cantilever loaded on the extension of the compression pad 20 when the horizontal extension 44 is at a maximum extension. The weighted base 60 has drive wheel(s) 61 and pivot wheel(s) 62 that allows the weighed base 60 of the portable CPR robot 10 to be positioned under a patient's bed or aside the bed. The handle 100 allows the base 60 to be easily rolled and positioned. The weighted base 60 is at least twice the maximum force of the chest compression.

A vertical post 41 extends from the base 60. A vertical extension 40 is vertically adjustable on the vertical post 41 to elevate the compression display 21. A vertical rotation 42 connects the vertical extension 40 to a horizontal arm 43. A horizontal extension 44 allows the compression pad 20 to be moved over a patient on a bed from a single side of the bed. At the end of the horizontal extension 44 is the compression display 21. The compression display 21 is preferably a touch display where a doctor or CPR specialist can enter, set, or change the CPR rates.

The head of the compression display 21 can be rotated to position the compression pad 20 in an optimal position and orientation on the chest of the patient. The compression pad 20 pushes downward onto the chest of the patient. The vertical extension 40 and the horizontal extension 44 are lockable to prevent movement of these components and the compression pad 20 exhorts forces onto the chest of a patient.

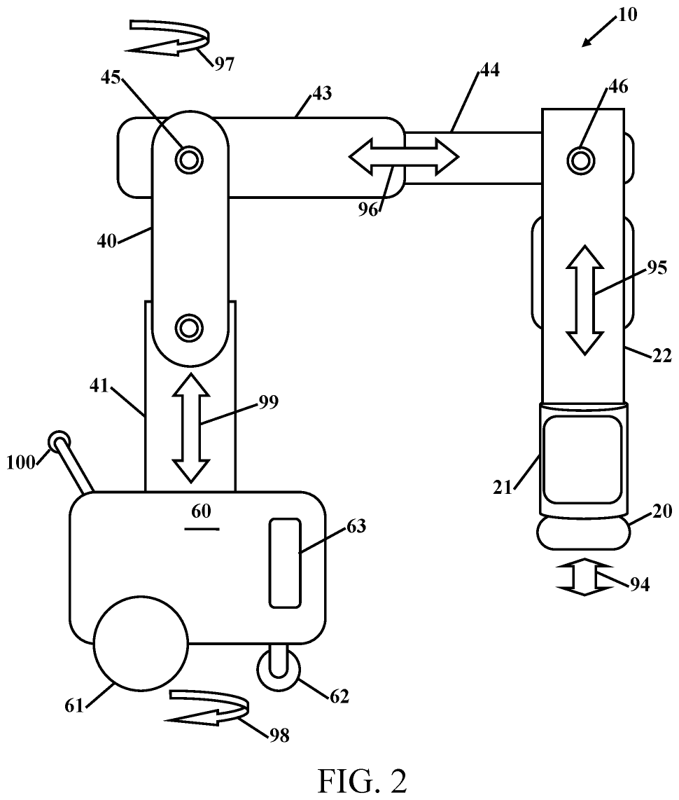

FIG. 2 shows a side plan view of the portable CPR robot 10. The base of the portable CPR robot 10 has a weighted base 60 that resists cantilever forces when compression pad 20 is pushing down on a person at optimal force when the horizontal is placed at any extension and rotation 97. Within the base 60 a battery 63 is shown to add weight to the base 60 the weighted base is equal to greater than the maximum force exerted by said compression pad. In other figures, additional components within the base 60 are shown and described. The weighted base 60 has large drive wheel(s) 61 and pivot wheel(s) 62 that allows the base 60 of the portable CPR robot 10 to be positioned under a patient's bed or aside the bed. The handle 100 allows the base 60 to be easily rolled and positioned.

A vertical post 41 is supported on the base 60. The vertical extension 40 is vertically adjustable 99 on the vertical post 41 to elevate the compression display 21. To get the bottom of the compression pad well above a person on a bed. The horizontal arm 43 can rotate 97 relative to the base 60. The horizontal extension 44 extends 96 from the horizontal arm 43. It is also contemplated that the horizontal extension 44 can move or extend 96 from the pivot 45. In another contemplated embodiment the horizontal arm 43 can pivot at pivots 45 and 46 to position the compression head 20 on the chest of a patient.

The horizontal extension 44 allows the compression pad 20 to be moved over a patient on a bed from a single side of the bed. The down column 22 may be designed to pivot 46 on the horizontal extension 44. At the end of the horizontal extension 44 is the compression display 21. The compression display 21 is preferably a touch display where a doctor or CPR specialist can enter, set, or change the CPR rates.

The head of the compression display 21 can be rotated and moved/locked vertically 95 to position the compression pad 20 in an optimal position and orientation on the chest of the patient. The compression pad 20 pushes downward 94 onto the chest of the patient. The vertical extension 40 and the horizontal extension 44 are lockable to prevent movement of these components and the compression pad 20 exhorts forces onto the chest of a patient.

The American Heart Association recommends pushing with enough force to compress the chest of a person 1.5 to 2 inches when performing CPR. To reach this amount of force requires 100 to 125 pounds of force. The compression force is adjustable from 1 pound for babies to 150 pounds or greater. CPR on an adult is typically applied with compressions at a rate of 100 to 120 compressions per minute. When a person is performing CPR, after 30 chest compressions are given and then two breaths are forced into the patient. For an infant or a child. 30 chest compressions at a rate of at least 100 compressions per minute.

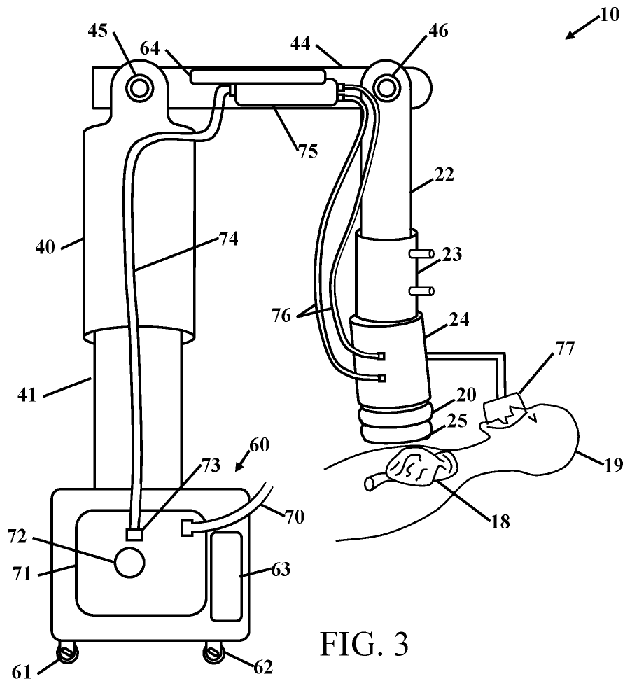

FIG. 3 shows another perspective view of the portable CPR robot 10. The base 60 is shown as a self-contained unit with a battery 63 that powers the portable CPR robot 10. The base has pivot wheel(s) 62 and fixed drive wheel(s) 61. One or more of the wheels can have a locking mechanism to prevent the base 60 from rolling. An air supply 70 to the portable CPR robot 10 with filtered air from the hospital that can be used for the chest compressions and optionally for ventilation to the patient 19. Within the portable CPR robot 10 is also a compressor 71 that turns ambient air or the air supply 70 to a pressure of about 100 to 125 psi. The air supply can also be used to supply the breathing mask 77 for patient ventilation of the breathing mask 77 can be connected to a separate ventilator.

A pressure gauge 72 is shown to verify or set the air pressure created by the compressor 71. A fitting or tube adapter 73 connect the output of the compressor 71 to a supply tube 74 that runs along the vertical post 41 and the vertical extension 41. The vertical post 41 and the vertical extension is an adjustable compressor arm. At the top of the vertical extension is the pivot 45 that connects to the horizontal extension 44. Another rechargeable battery 64 can be within the horizontal extension 44. The supply tube 74 connects to an air controller 75.

The air controller 75 controls two directional movement to a cylinder 24 that moves the compression pad 20. Bi-directional control of the air-lines 76 allows the portable CPR robot 10 to control and adjust both the force and speed of both the downward chest compression and the return stroke/speed. The stroke is adjustable for optimal effectiveness of the chest compressions on the heart 18 of the patient 19. It should be noted that the cylinder 24 can pivot on the adjustable chest arm 23 to and angle (if needed) to conform to the chest shape. The adjustable chest arm 23 is connected to the down column 22 that is connected to the pivot 46 on the horizontal extension 44. One or more sensors in the compression pad 20 and/or the cylinder 24 can monitor and control the stroke rate and stroke distance. The stroke also has an adjustable stroke pressure profile over time to control the force and acceleration rate of the chest compression on both the down and the up stroke. This can also include a dwell time for briefly holding the pressure on the chest to allow for blood flow out of the heart. A pressure sensor 25 can indicate the delivery of the chest compressions.

The pressure sensor (or other sensors) can rest on the chest of the patient 19 between compressions to determine if the heart 18 is beating on its own, thereby additional chest compressions may be suspended. Ideal chest compressions are 1.5 to 2 inches at a rate of between 70 to 120 chest compressions per minute. Monitoring for natural heart rhythm allows the robot to sync chest compressions with the heart rhythm as is restarts and can stop future chest compressions when a stable heart is restored. The sensor can determine the amount of force that is being applied and can provide a total for or a topographical display of the force(s) exerted on the chest of the patient 19. The outer surface can rhythmically follow natural heart beats and breathing.

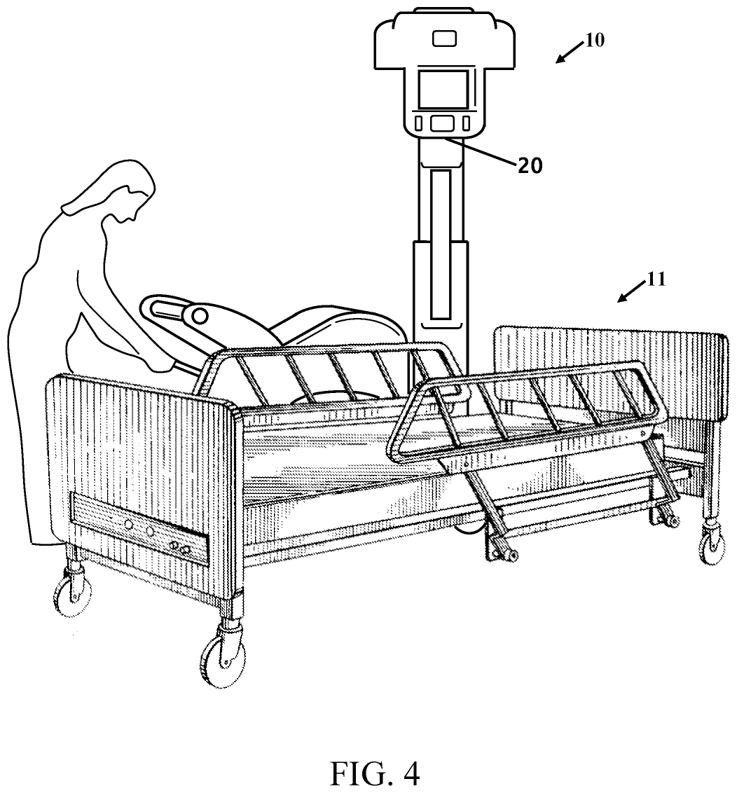

FIG. 4 shows a perspective view of the portable CPR robot 10 over a hospital bed 11. From this figure the portable CPR robot 10 is shown with the compression pad 20 far above the bed 11. This allows the doctor or heath care provider plenty of room to move the compression pad 20 over the rails, bed, and patient to properly and quickly located the compression pad 20 in an optimal position on a patient. It further can also be quickly lifted out and away from the patient when not needed.

Other types of CPR involve Interposed Abdominal Compression or IAC CPR is basically a 3-rescuer technique-an abdominal compressor, the chest compressor and the rescuer providing ventilations. This technique includes, conventional chest compressions combined with alternating abdominal compressions. The MC CPR helps to increases diastolic aortic pressure and venous return, leading to improved coronary perfusion pressure and blood flow to other vital organs. The portable CPR robot 10 can be configured to perform the IAC CPR, thereby autonomously performing the function of three people.

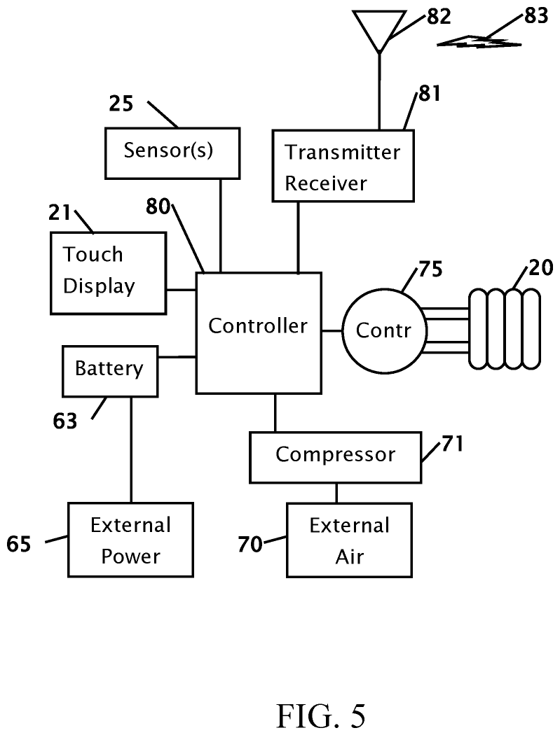

FIG. 5 shows a block diagram of the electrical components of the portable CPR robot 10. This block diagram shows the controller 80 is powered by at least one battery 63 that can be charged from an external power 65 source. The battery 63 allows the portable CPR robot 10 to be used away from a power line. The controller operates the compressor 71 that increases the pressure from an external air 70 source or can compress the air from the filtered ambient air. The touch display 21 allows for a user interface to set operating parameters. The controller 80 will operate the air controller 75 that will adjust the stroke(s) of the compression pad 20. The sensors 25 will monitor operation of the portable CPR robot 10 and can adjust. In this embodiment a transmitter/receiver 81 is shown that can communicate a signal 83 with hospital records and databases through an antenna 82. In a quick use, the care provider can simply bring the compression pad 20 onto a patient and start the portable CPR robot 10. Default parameters will at least approximate a person with some CPR training.

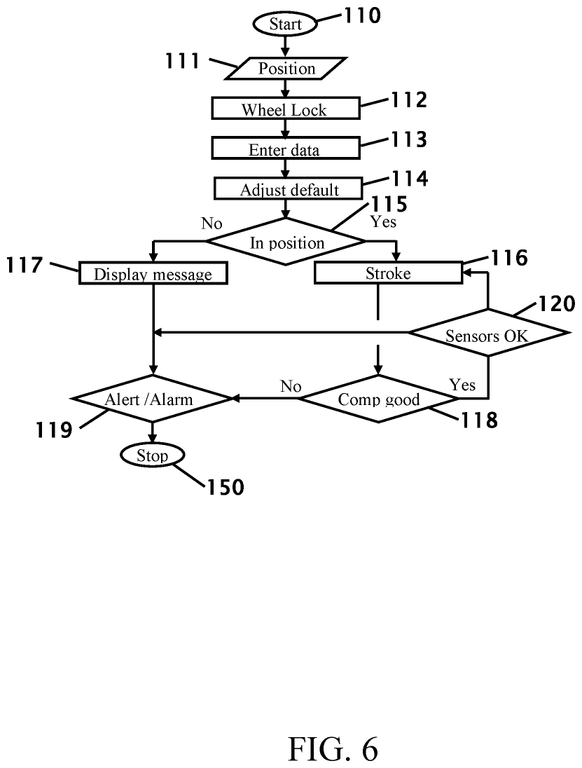

FIG. 6 shows a flow chart of using the portable CPR robot 10. From the start 110 the compression pad of the portable CPR robot is positioned 111 over the heart of a user. The wheel(s) are locked 112 to prevent the robot from moving while it performs chest compressions. The patient information data is entered 113 such as, but not limited to age, weight, and gender. This provides some initial values for the CPR from a database. The doctor or other health care provider can adjust the default 114 values. A final check is performed to verify that the compression pad is in position and the robot can start CPR. For each chest compression stroke 116 the robot sensors can verify and adjust the stroke. Any anomaly can be displayed 117. If an error is detected in the compression 118, from one or more of the sensors 120 (such as a low battery or air pressure) or the care provider wants to stop 150 the chest compression the robot can be stopped 150. From one or several conditions the robot can sound an alert or alarm 119.

Thus, specific embodiments of a portable CPR robot have been disclosed. It should be apparent, however, to those skilled in the art that many more modifications besides those described are possible without departing from the inventive concepts herein. The inventive subject matter, therefore, is not to be restricted except in the spirit of the appended claims.

### SEQUENCE LISTING

Not Applicable.

1. A portable CPR robot comprising:
a weighted base;
said weighted based connected to a cantilevered arm;
said cantilevered arm having a compression pad that is configurable to provide repeated strokes;
said cantilevered arm being configured to extend over a hospital bed;
said repeated strokes having a stroke length of between 0.5 and 4 inches;
said repeated strokes having a stroke rate of between 70 and 120 strokes per minute, and said weighted base is weighted to prevent rotation of said cantilevered arm while said compression pad is in operation.

2. The portable CPR robot according to claim 1, further includes a rechargeable battery.

3. The portable CPR robot according to claim 1, further includes a height adjustment to said compression pad.

4. The portable CPR robot according to claim 1, further includes a user interface that allows for adjustment of said stroke length and said stroke rate.

5. The portable CPR robot according to claim 4, further includes and adjustable stroke pressure profile over time.

6. The portable CPR robot according to claim 5, further includes adjustable down stroke profile, adjustable up stroke profile and dwell time.

7. The portable CPR robot according to claim 1, wherein the compression pad is pneumatically operated.

8. The portable CPR robot according to claim 7, further includes a sensor that measures the pressure within the compression pad.

9. The portable CPR robot according to claim 1, wherein said weighted base is equal to greater than the maximum force exerted by said compression pad.

10. The portable CPR robot according to claim 1, wherein said compression pad includes a temperature sensor.

11. The portable CPR robot according to claim 1, wherein said compression pad includes an electrocardiogram (EKG), (ECG) sensor.

12. The portable CPR robot according to claim 1, wherein at least a portion of said weighted base is configured to extend under said hospital bed to a position under at least a portion of said compression pad.

13. The portable CPR robot according to claim 1, further includes an ability to stop chest compressions when said portable CPR robot detects a stable heart rate.

14. The portable CPR robot according to claim 1, further includes an ability to sync chest compressions with natural heart rhythm and breathing.

15. The portable CPR robot according to claim 1, further includes at least one of an X-ray, an air/breathing function, and a defibrillator

16. The portable CPR robot according to claim 1, further includes abdominal compression function.

17. The portable CPR robot according to claim 1, further includes a wired or wireless link to at least one of medical information, medical resources, patients records and medical diagnostic tools.

18. The portable CPR robot according to claim 1, wherein said compression pad is adjustable to supply a compression force of between 1 and 150 pounds of force.

19. The portable CPR robot according to claim 1, further includes a breathing ventilation function that is configured to forces a breathing function.

20. The portable CPR robot according to claim 1, further includes an ultrasonic sensor that is used to position, or re-position said compression pad head.
